(19) United States
(12) Patent Application Publication
(10) Pub. No.: US 2009/0210529 A1
(43) Pub. Date: Aug. 20, 2009

(54) REWARD SYSTEM AND METHOD FOR A USER OF A COMPUTING SYSTEM

(76) Inventor: Talmon Marco, New York, NY (US)

Correspondence Address: CENTURY IP GROUP, INC. [Main], P.O. BOX 7333, NEWPORT BEACH, CA, 92658-7333, US

(21) Appl. No.: 12/347,888

(22) Filed: Dec. 31, 2008

Related U.S. Application Data
(60) Provisional application No. 61/029,575, filed on Feb. 19, 2008.

(51) Int. Cl. G06F 15/173

(52) U.S. Cl. 709/225

(57) ABSTRACT

A method for controlling reward for a user of a computing system, the method comprising monitoring use level of a first tool provided in a computing environment, wherein the first tool provides at least a first service; and rewarding a first entity according to the use level, such that the reward is determined based on the use level of the first tool over a second tool that provides at least the first service.

### CROSS-REFERENCE TO RELATED APPLICATIONS

Pursuant to 35 USC 119, this application claims priority to and the benefit of earlier filing date of Provisional Application Ser. No. 61,029,575 filed on Feb. 19, 2008 the content of which is hereby incorporated by reference herein.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present invention relates generally to computing environments and, more particularly, to a system and method for rewarding a user of a computing device for complying with certain policies when using the computing system.

### BACKGROUND

The advent of the internet has opened the door for new ways to engage in targeted advertising and consumer profiling. To profile the an audience, many companies provide search interfaces and other services at little or no cost in exchange for the expectation that they will be able to promote advertising material or gather valuable consumer information when a consumer uses such tools or services to search or browse internet content.

For example, Google, Microsoft and Yahoo each provide a search toolbar or a home page that can be used by a consumer to search for content available on the internet either based on classification or a keyword search. When a user enters one or more search phrases, the search tool not only provides the user with the search results, it also displays to the user advertisements that correspond to those search terms.

The revenue generated from targeted advertising using the above schemes is so important that the search interface providers continue their fight for capturing larger market share by incentivizing the use of their search interface or homepage over their competitors. The incentives come in many different forms. For example, Google, Microsoft and Yahoo each provide the users with free email accounts and other services (e.g., free navigation maps, personal calendar, etc.) to encourage the users to use their toolbars or visit their homepages on a regular basis.

Unfortunately, currently no reliable method exists that can appropriately reward a consumer by monitoring the level of use of a certain tool. For example, a consumer may use Yahoo maps and email service for free but use Google's search engine. In such an example, Yahoo is not benefiting from the advertisement revenues that are generated and paid to Google, but is fronting the costs for the free services provided to the user. System and methods are needed that can overcome the above shortcomings.

### SUMMARY

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for controlling reward for a user of a computing system is provided. The method comprises monitoring use level of a first tool provided in a computing environment, wherein the first tool provides at least a first service; and rewarding a first entity according to the use level, such that the reward is determined based on the use level of the first tool over a second tool that provides at least the first service.

A first level of reward is provided to the first entity, when the entity uses the first tool less than a first use threshold, and a second level of reward is provided to the entity, when the entity uses the first tool more than the first use threshold. The second level of reward is more beneficial to the entity than the first level of reward. A second entity benefits from the first entity's using the first tool according to the first entity's use level of the first tool.

In one embodiment, a third entity causes the second entity to benefit from the first entity's use of the first tool wherein the second entity provides the first entity with access to the first tool. The second entity controls the monitoring and the rewarding processes and the first entity's use of the first tool provides a benefit to the third entity, for example. The first entity's use of the first tool generates revenues for the third entity due to the third entity's ability to provide promotional material to the first entity. The first entity's use of the first tool generates revenues for the third entity due to the third entity's ability to gather profile information about use patterns of the first entity.

In accordance with certain embodiments, a method for providing audio/video content comprises monitoring use level of web services by a user of a computing environment; and rewarding the user of the web services according to the use level by providing the user with free or discounted access to audio/video content available on over a network, such that the reward is determined based on the user using a first web service according to a predetermined threshold. Depending on implementation, use of the first web service is optional and a lower level of use is associated with a lower reward.

In one embodiment, the user is allowed to access a first quantity of audio/video content within a first time period, in response to the user using the first web service for at least a predetermined number of times or at least a predetermined length of time, within said first time period. The user's access to the audio/video content may be limited, in response to determining that the user has not used the first web service for at least a predetermined number of times or at least a predetermined length of time, within said first time period.

The user's access to the audio/video content may be in the form of content downloaded from the network to a user device or in the form of content streamed in real-time from the network to a user device. The monitoring is performed by a first entity having a relationship with one or more web service providers, such that the web service providers have a revenue sharing arrangement with the first entity according to use level of a particular web service by the user. The web service providers' revenues are generated based on advertisements presented to a user while the user is using one of the web services to access content over the web. The web may comprise the Internet and/or communications networks.

A computer program product comprising a computer useable medium having a computer readable program is provided, wherein the computer readable program when executed on a computer causes the computer to monitor use level of web services by a user of a computing environment; and allow the user to access a first quantity of audio/video content within a first time period, in response to the user using a first web service for at least a predetermined number of times or at least a predetermined length of time, within said first time period.

In accordance with one implementation, a system comprising one or more logic units is provided. The one or more logic units are configured to perform the functions and operations associated with the above-disclosed methods. In yet another implementation, a computer program product comprising a computer useable medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary software environment in accordance with one or more embodiments of the invention, wherein a computing system can access content provided over a network.

FIG. 2 is a flow diagram of a method for content delivery, in accordance with one embodiment.

FIG. 3 is a block diagram of an exemplary set of media delivery modules configured in accordance with one embodiment.

FIGS. 4 and 5 are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

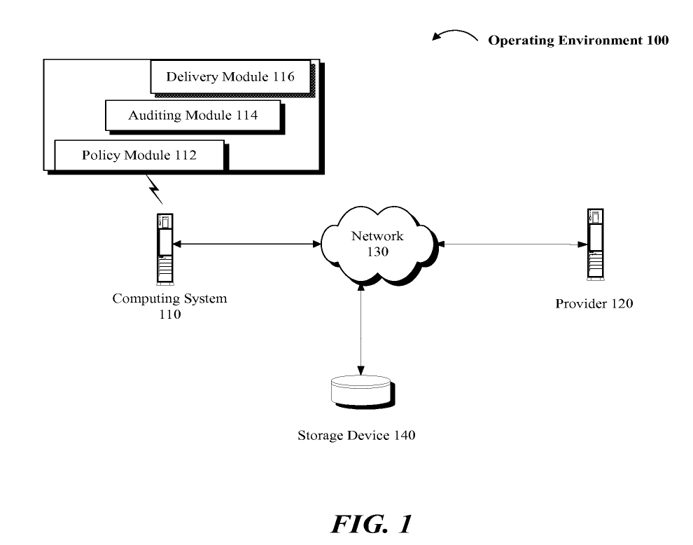

Referring to FIG. 1, an exemplary operating environment 100 is illustrated in which a computing system 110 is connected to a provider 120 over a network 130 (e.g., the internet). Provider 120 may include a server system to service computing system 110's requests. In one exemplary implementation, provider 120 may provide content comprising text, audio, video or multimedia data stored on one or more storage devices 140. Storage devices 140 may be coupled to the provider 120 or computing system 110, either locally or remotely.

Computing system 110 may be implemented to load and execute logic code in form of software modules that cause computing system 110 to perform certain functions related to delivery and display of content provided by provider 120. In an exemplary embodiment, one or more modules are implemented to manage or control different aspects of content delivery and display. In one embodiment, a policy module 112, an auditing module 114 and a delivery module 116 may be configured to manage content delivery in a controlled environment.

Without limitation, the policy module 112 may be configured to establish a set of policies (e.g., requirements) to which a user is to adhere; the auditing module 114 may be configured to determine whether the user has complied with the set of policies; and the delivery module 116 may be configured to allow or block delivery of content to a user using the computing system 110 according to the results generated by the auditing module 114 as provided in further detail below.

The above three exemplary modules may be implemented in form of logic code executable in whole or in part on computing system 110 or a server system connected to network 130. Certain embodiments suggested herein are disclosed as applicable to delivery of media content. It is noteworthy, however, that in different embodiments, the concepts and configurations disclosed herein may be applicable to delivery of any other type of content or even physical items as a reward in exchange for compliance with predetermined policies set by provider 120.

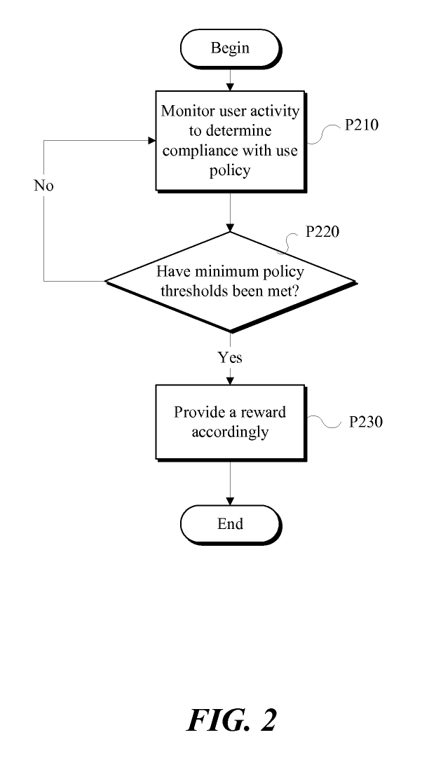

Referring to FIGS. 1 and 2, a provider 120 or other entity interested in rewarding a user in consideration for the user's compliance with a set of policies (i.e., use policy) may monitor user activity to determine whether the user is in compliance with such use policy (P210). Depending on implementation, one or more modules (e.g., policy module 112, auditing module 114, and delivery module 116) may be installed on a system used by the user to facilitate the monitoring of the level of use and effectuate a reward according to user compliance with the use policy.

The use policy may require, entice or prompt the users to, for example, search the Internet using a preferred search mechanism, purchase products using the a preferred website, or set the default homepage to a preferred web portal that provides one or more services (e.g., news, email, maps, etc.). In other words, provider 120 may set any policy that would result in generation of traffic on a preferred website or would allow for collection of user profile data for commercial advantage or monetary profit.

For example, a provider 120 may want to offer users the right and a mechanism to download or listen to streaming music free of charge or at a discounted rate as compensation for the users' adherence to the use policy set by provider 120. According, provider 120 is able to provide the users with free or discounted services or products in anticipation for future revenues generated from the user's compliance with the use policy. Said revenues may be generated, for example, by way of the user clicking or viewing promotional material (e.g., advertisements) displayed on a preferred medium (e.g., a preferred search mechanism, a preferred home page or portal, etc.) or by commissions paid to provider 120 from product sales generated from the users' adherence to the use policy.

To accomplish the above, policy module 112 may be configured to allow provider 120 to set and/or enforce the use policy and also monitor users' compliance therewith. For example, the use policy may require a user to exclusively use a preferred search mechanism by enabling a user to install policy module 112 on computing system 110. Policy module 112 may cause user search queries to be directed to the preferred search mechanism and even prevent the user from using any other search service.

In one implementation, policy module 112 may intercept requests submitted by a web browser running on computing system 110 to determine whether the requests are associated with a search query (e.g., a request that is to be sent to Google or Yahoo search engines). If so, policy module 112 may direct the search query to the preferred search mechanism. In this manner, policy module 112 may control or direct traffic to predetermined websites or service providers, either by way of strict enforcement of the use policy or by way of prompting the user to use a preferred site or service.

In embodiments where a strict compliance with the use policy is not implemented (i.e., the user is given the option to comply with or reject the use policy) an auditing module 114 may be installed on computing system 110 to track user's choice on whether to comply with the use policy. For example, if the use policy indicates that users should use a preferred search tool, the auditing module 114 may track the user's browser setting to determine to what degree the user actually uses the preferred search tool.

In one embodiment, the auditing module 114 may be implemented as a browser helper object (BHO), for example. The BHO may attach to the browser on computing system 110 and determine the default search mechanism or the browser's home page setting (e.g., by reading a registry key or a browser settings file). The BHO may be configured to check the settings at predetermined time intervals (e.g., using a timer event) or use a notification mechanism to track browser events that indicate a change in the default search mechanism or home page settings, for example.

Accordingly, auditing module 114 monitors user activity and interaction with computing system 110 to determine whether minimum use policy thresholds have been met (P220). That is, in an embodiment where the user is given the flexibility to optionally deviate from the use policy, auditing module 114 measures the degree with which the user have complied with the use policy. In this manner, when the user is ready to benefit from the goods or services (e.g., music) provided by provider 120, then delivery module 116 can reward the user according to the user's level of compliance with the use policy (P230).

It is noteworthy that in certain embodiments, the services provided according to the use policy and also the goods or services that are offered as a reward to the user for compliance with the use policy may not be directly provided by provider 120. That is, provider 120 may act as a facilitator for promoting or delivering the goods or services, while the actual goods or service may be originated, manufactured or sold by other entities with an arm-length relationship with the provider 120. In this manner, the provide 120 benefits from promoting selected services as part of the use policy, in exchange for a royalty or other form of compensation.

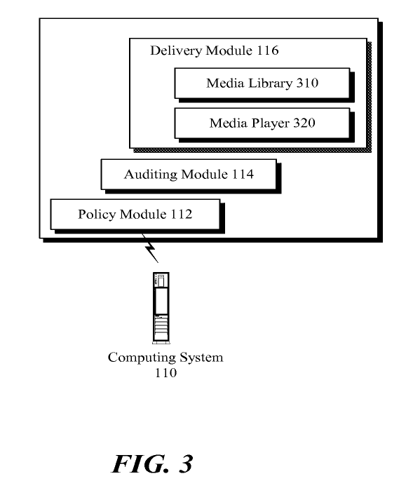

In one exemplary implementation, delivery module 116 provides the user with access to content such as music, video, software, video games and other protected content for free or at a discount. As noted, delivery module 116 delivers content if the auditing module 114 confirms user conformance with minimum use policy requirements. In this example, delivery module 116 may include, for example, a media library 310 and a media player 320 such that before performing a requested action by the user (e.g., a request for downloading or streaming content) the media player communicates with the auditing module 114 to determine whether the content is to be played (see FIG. 3).

In different embodiments, the invention can be implemented either entirely in the form of hardware or entirely in the form of software, or a combination of both hardware and software elements. For example, computing system 110 may comprise a controlled computing system environment that can be presented largely in terms of hardware components and software code executed to perform processes that achieve the results contemplated by the system of the present invention.

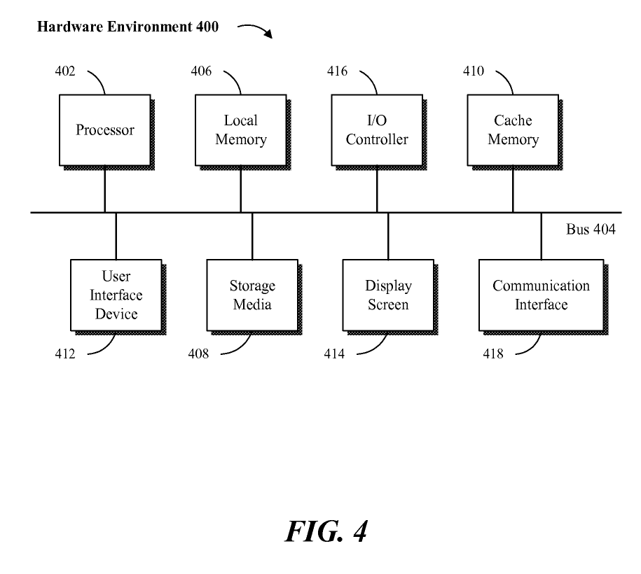

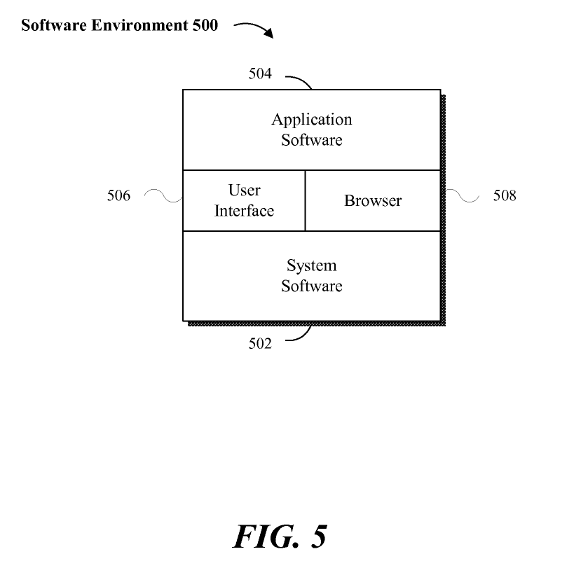

Referring to FIGS. 4 and 5, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In one embodiment, policy module 112, auditing module 114 and delivery module 116 may be implemented as system software 502 and application software 504 executed on one or more hardware environments. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 4, an embodiment of the system software 502 and application software 504 can be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 5, system software 502 and application software 504 can comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for controlling reward for a user of a computing system, the method comprising:
monitoring use level of a first tool provided in a computing environment, wherein the first tool provides at least a first service; and
rewarding a first entity according to the use level, such that the reward is determined based on the use level of the first tool over a second tool that provides the first service.

2. The method of claim 1 wherein a first level of reward is provided to the first entity, when the entity uses the first tool less than a first use threshold, and a second level of reward is provided to the entity, when the entity uses the first tool more than the first use threshold.

3. The method of claim 2 wherein the second level of reward is more beneficial to the entity than the first level of reward.

4. The method of claim 1 wherein a second entity benefits from the first entity's using the first tool according to the first entity's use level of the first tool.

5. The method of claim 4, wherein a third entity causes the second entity to benefit from the first entity's use of the first tool wherein the second entity provides the first entity with access to the first tool.

6. The method of claim 5 wherein the second entity controls the monitoring and the rewarding processes.

7. The method of claim 6 wherein the first entity's use of the first tool provides a benefit to the third entity.

8. The method of claim 7 wherein the first entity's use of the first tool generates revenues for the third entity due to the third entity's ability to provide promotional material to the first entity.

9. The method of claim 7 wherein the first entity's use of the first tool generates revenues for the third entity due to the third entity's ability to gather profile information about use patterns of the first entity.

10. The method of claim 1 wherein use of the first tool is optional and a lower level of use is associated with a lower reward.

11. A method for providing audio/video content, the method comprising:
monitoring use level of web services by a user of a computing environment; and
rewarding the user of the web services according to the use level by providing the user with free or discounted access to audio/video content available on over a network, such that the reward is determined based on the user using a first web service according to a predetermined threshold.

12. The method of claim 11 further comprising allowing the user to access a first quantity of audio/video content within a first time period, in response to the user using the first web service for at least a predetermined number of times or at least a predetermined length of time, within said first time period.

13. The method of claim 12 further comprising limiting the user's access to the audio/video content, in response to determining that the user has not used the first web service for at least a predetermined number of times or at least a predetermined length of time, within said first time period.

14. The method of claim 12 wherein user access to the audio/video content is in the form of content downloaded from the network to a user device.

15. The method of claim 12 wherein user access to the audio/video content is in the form of content streamed in real-time from the network to a user device.

16. The method of claim 11 wherein the monitoring is performed by a first entity having a relationship with one or more web service providers, such that the web service providers have a revenue sharing arrangement with the first entity according to use level of a particular web service by the user.

17. The method of claim 16, wherein the web service providers' revenues are generated based on advertisements presented to a user while the user is using one of the web services to access content over the web.

18. The method of claim 11, wherein the web comprises the Internet.

19. The method of claim 11 wherein use of the first web service is optional and a lower level of use is associated with a lower reward.

20. A computer program product comprising a computer useable medium having a computer readable program, wherein the computer readable program when executed on a computer causes the computer to:
monitor use level of web services by a user of a computing environment; and
allow the user to access a first quantity of audio/video content within a first time period, in response to the user using a first web service for at least a predetermined number of times or at least a predetermined length of time, within said first time period.
